(19) United States
(12) Patent Application Publication
(10) Pub. No.: US 2025/0292555 A1
(43) Pub. Date: Sep. 18, 2025

(54) INFORMATION PROCESSING APPARATUS AND CONTROL METHOD THEREFOR

(71) Applicant: CANON KABUSHIKI KAISHA, Tokyo (JP)

(72) Inventors: Kenshi SAITO, Kanagawa (JP); Shuhei OGAWA, Saitama (JP)

(21) Appl. No.: 19/070,617

(22) Filed: Mar. 5, 2025

(30) Foreign Application Priority Data
Mar. 13, 2024 (JP) 2024-038767

(51) Int. Cl. G06V 10/776; G06V 10/74; G06V 10/82

(52) U.S. Cl. CPC G06V 10/776; G06V 10/761; G06V 10/82

(57) ABSTRACT

An information processing apparatus for managing a plurality of learning models, comprises: a model management unit that manages, for each of the plurality of learning models, first information for identifying a data set used to learn the learning model, and second information for identifying an initial model used to learn the learning model; a data management unit that manages third information concerning a plurality of data sets each identified by the first information of each of the plurality of learning models; a reception unit that receives an instruction of incremental learning using, as an initial model, a predetermined learning model included in the plurality of learning models; and a determination unit that determines, based on the first information, the second information, and the third information, a data set to be used for the incremental learning from the plurality of data sets.

### BACKGROUND OF THE INVENTION

### Field of the Invention

The present invention relates to a technique for managing learning models and learning data.

### Description of the Related Art

In recent years, the accuracy of image recognition techniques such as image classification, object detection, and object tracking has remarkably been improved due to advent of a deep neural network (DNN). In general, to learn a DNN model, a large amount of data is required but it is difficult for individuals to collect such large amount of data. To cope with this, a method called fine tuning in which only some of the layers of a DNN model are learned by using, as an initial model, a model learned in advance using a large amount of data is sometimes performed. In fine tuning, a tendency to forget information obtained by a task of an initial model is known. Thus, a status in which fine tuning is repeated using learning data irrelevant to the initial model may occur.

Japanese Patent Laid-Open No. 2022-179162 (patent literature 1) discloses a method of selecting data useful for learning by calculating the similarity between labels, and considering, as a positive example, a case where the similarity is large and considering, as a negative example, a case where the similarity is small. In addition, Jiangfan Han, Ping Luo, Xiaogang Wang, “Deep Self-Learning From Noisy Labels”, arXiv: 1908.02160, 2019 (non-patent literature 1) discloses a method of calculating the similarity between learning data based on some of the outputs of the layers of a DNN model and correcting the learning data to obtain a label with high likelihood based on the similarity. With these methods, it is possible to improve the learning accuracy even if the learning data include an incorrect ground truth.

However, in the method disclosed in patent literature 1, the learning accuracy readily decreases when the learning data includes data arbitrarily annotated by the user. In addition, in non-patent literature 1, since the learning data are corrected using existing learned models, if the learning data include a group of arbitrarily annotated data, it is impossible to effectively correct/select the learning data.

### SUMMARY OF THE INVENTION

According to one aspect of the present invention, an information processing apparatus for managing a plurality of learning models, comprising: a model management unit that manages, for each of the plurality of learning models, first information for identifying a data set used to learn the learning model, and second information for identifying an initial model used to learn the learning model; a data management unit that manages third information concerning a plurality of data sets each identified by the first information of each of the plurality of learning models; a reception unit that receives an instruction of incremental learning using, as an initial model, a predetermined learning model included in the plurality of learning models; and a determination unit that determines, based on the first information, the second information, and the third information, a data set to be used for the incremental learning from the plurality of data sets, wherein the determination unit determines, as a data set to be used for the incremental learning, a data set used to learn a learning model whose evaluation accuracy is not lower than a predetermined accuracy at the time of inputting a predetermined data set to each of at least one learning model used as the initial model of the predetermined learning model.

The present invention improves the model learning accuracy.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional configuration of an information processing apparatus;

FIG. 2 is a view showing the procedure of processing in the information processing apparatus;

FIG. 3 is a flowchart of learning processing in the information processing apparatus;

FIG. 4 shows tables each showing an example of information added to a model;

FIG. 5 shows tables each showing an example of information added to data;

FIG. 6 is a view showing an example of traceability information;

FIG. 7 is a view showing an example of learning data;

FIG. 8 is a view for explaining a difference in ground truth due to different targets;

FIG. 9 is a flowchart of learning processing in an information processing apparatus (second embodiment);

FIG. 10 is a view showing an example of learning data (modification); and

FIG. 11 shows tables each showing an example of information added to a model (modification).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the present invention, an information processing apparatus that manages the history of learning models and learning data as traceability information will be exemplified below.

### <Overview>

When performing incremental learning for a learning model (learned model) using learning data, there is a tendency to lose information of a task (for example, the trunk of a person) targeted by an initial model and shift to a new task (for example, the whole body of a person). This shift is called catastrophic forgetting.

To cope with this, the information processing apparatus according to this embodiment manages traceability information representing how the models and the data were created in the past (that is, the past history of the models and the data). Then, the information processing apparatus selects learning data to be used for incremental learning based on an evaluation accuracy when inputting a predetermined data set to each model obtained by tracing the traceability information. This can select learning data similar to a learning target or learning data with a similar ground truth in incremental learning, thereby improving the model learning accuracy.

### <Apparatus Configuration>

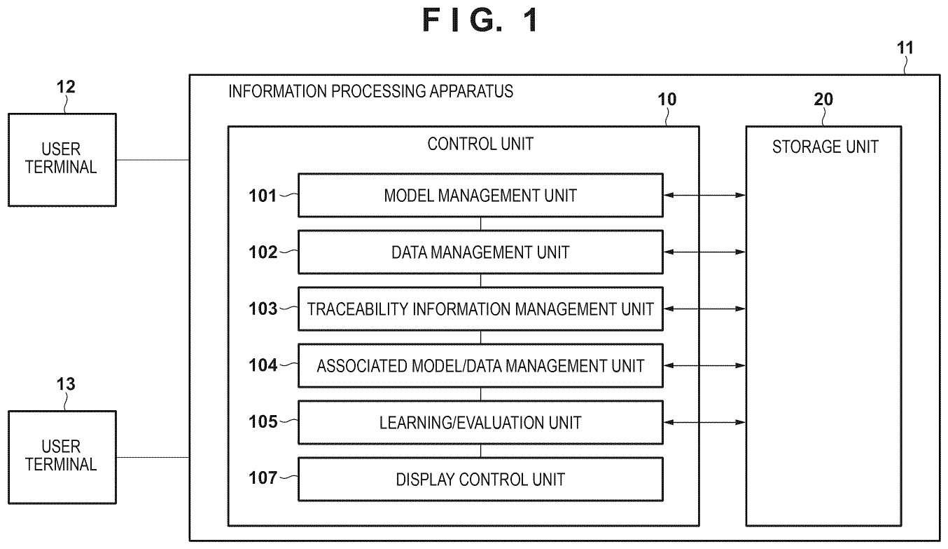

FIG. 1 is a block diagram showing the function configuration of an information processing apparatus 11. The information processing apparatus 11 manages a “model” and “data” used to learn and evaluate the model. Furthermore, the information processing apparatus 11 learns a model, edits data, or registers model information in response to a request from a user. Assume here that the model and data can be used by the third party via a learning model public platform. That is, the user is a user of the learning model public platform.

The information processing apparatus 11 is communicably connected to user terminals 12 and 13 via a communication network such as a local area network (LAN) or the Internet. The connection method is not particularly limited. For example, each user terminal may be connected via a wire or connected via wireless communication. Note that FIG. 1 shows two user terminals, but the present invention is not limited to this. Assume that each user terminal is an information terminal such as a personal computer (PC), a mobile phone, or a tablet terminal apparatus.

The information processing apparatus 11 includes a control unit 10 and a storage unit 20. The control unit 10 can be implemented when, for example, a central processing unit (CPU) executes various kinds of programs stored in the storage unit 20. The storage unit 20 is a random access memory (RAM), a read only memory (ROM), or a mass storage device such as a hard disk drive (HDD) or a solid-state drive (SSD).

The control unit 10 includes a model management unit 101, a data management unit 102, a traceability information management unit 103, an associated model/data management unit 104, a learning/evaluation unit 105, and a display control unit 107. As described above, these functional units can be implemented when, for example, the CPU executes various kinds of programs. However, some or all of the functional units may be implemented by hardware such as an Application Specific Integrated Circuit (ASIC).

The model management unit 101 manages models registered in the information processing apparatus 11. This embodiment assumes that the model is an “object detection model” that aims at performing object detection as one form of image recognition, but the present invention is not limited to this. The model may be a speech recognition model, a natural language processing model, or a generative artificial intelligence (AI) model. The model management unit 101 manages the models by adding model information to each model.

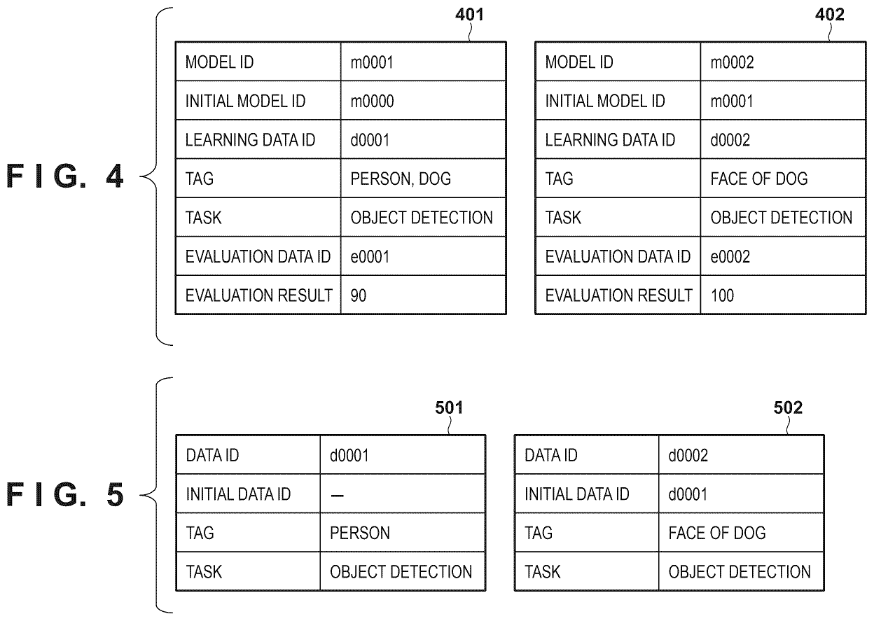

FIG. 4 shows tables of examples of model information 401 and model information 402 added to two models, respectively. The model information is attribute information of the model, and includes pieces of information of a model ID, an initial model ID, a learning data ID, a tag, a task, an evaluation data ID, and an evaluation result. That is, the model information includes pieces of identification information (IDs) for identifying the initial model and the data used to generate the model.

The model ID is model-specific identification information (ID) for identifying each model. The initial model ID is a model ID for designating a model that serves as an initial parameter when learning each model.

Referring to FIG. 4, in the model information 401, the model ID is “m0001” and the initial model ID is “m0000”. In the model information 402, the model ID is “m0002” and the initial model ID is “m0001”. Therefore, it is indicated that the model with the model ID “m0002” is a model obtained as a result of performing learning by using the model with the model ID “m0001” as the initial model.

The learning data ID is a learning data-specific ID for identifying a data set used to learn each model. In the tag, information of an object targeted by each model, information necessary for the user to search for a model, or the like is described. In the task, a type of processing (object detection, image generation, or the like) targeted by each model is described. The evaluation data ID is a data ID for designating a data set used to evaluate each model. In the evaluation result, a numerical value obtained as a result of evaluation or the like is described.

As shown in FIG. 4, the model information 401 or 402 is model information of a model for an object detection model. For example, if the model is a model of another type (a speech recognition model or the like), items included in the model information may be different from those in the example shown in FIG. 4.

The data management unit 102 manages data registered in the information processing apparatus 11. The data according to this embodiment is image data for object detection. The data management unit 102 receives registration of a data set from the user, and manages the data set by adding data information to the data set.

FIG. 5 shows tables showing examples of data information 501 and data information 502 added to data (image data sets), respectively. The data information is attribute information of data and includes pieces of information of a data ID, an initial data ID, a tag, and a task.

The data ID is a data-specific ID for identifying each data. The initial data ID is the data ID of an initial data set used to create the data. In the tag, information of an object targeted by each data, information necessary for the user to search for data, or the like is described. In the task, a type of processing (object detection, image generation, or the like) targeted by each data is described.

For example, since the initial data ID in the data information 502 is “d0001”, it is indicated that data corresponding to the data information 502 is edited (created) using data corresponding to the data information 501 as the initial data. The editing method is performed by an operation of, for example, changing an annotation or processing an image.

As shown in FIG. 5, the data information 501 or 502 is data information of data used for a model for an object detection model. For example, if the data is data used for a model of another type (a speech recognition model or the like), items included in the data information may be different from those in the example shown in FIG. 5.

The traceability information management unit 103 manages traceability information of models and data. The traceability information is information representing how the models and the data were created in the past (that is, the past history).

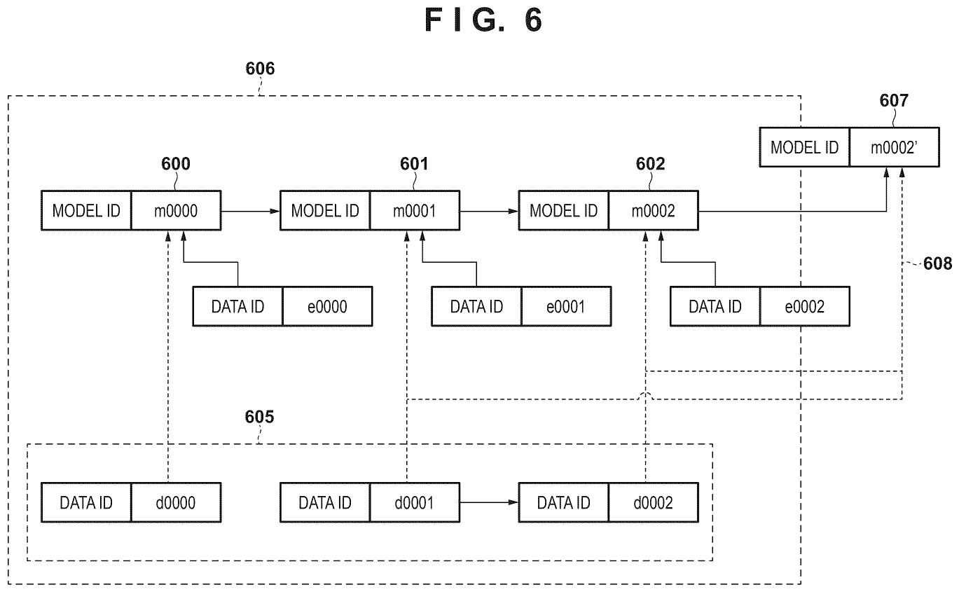

FIG. 6 is a view showing an example of the traceability information. Referring to FIG. 6, a solid arrow represents the derivative relationship between models or between data. That is, the relevance between a plurality of learning models published on the learning model public platform and the relevance between a plurality of data sets are integrated and managed. Referring to FIG. 6, a dotted arrow represents data used to learn each model. In addition, a pair of a model and data is associated with evaluation data (“e0000” to “e0002”). As described above, the evaluation data is a data set used to evaluate each model.

For example, it is indicated that a model 602 (“m0002”) is a derived model created by performing incremental learning by using a model 601 (“m0001”) as the initial model and using data (“d0002”). It is also indicated that the data (“d0002”) is derived data created (edited/added) based on the data (“d0001”).

As described above, the traceability information indicates records obtained by editing the models and the data in the past. By tracing the traceability information, it is possible to identify one or more models used to create each model. It is also possible to identify one or more data used to create each data.

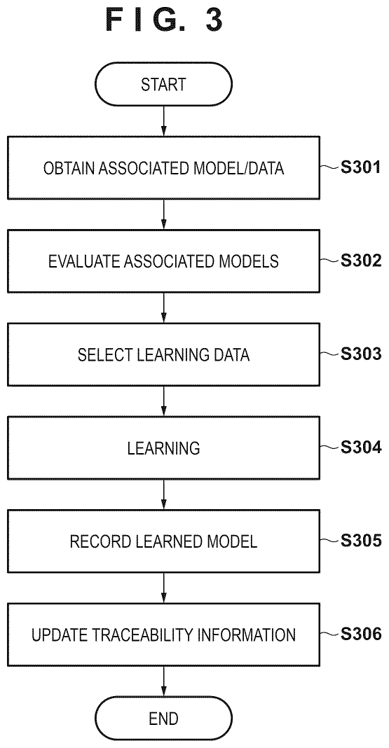

The associated model/data management unit 104 obtains an associated model, evaluation data, and learning data based on a model obtainment instruction from the user. Details of the associated model/data management unit 104 will be described later with reference to FIG. 3.

The learning/evaluation unit 105 learns or evaluates the model based on the available model and data. Note that when newly learning a model, the traceability information management unit 103 updates the traceability information based on the model information linked with the model and the data information linked with the data.

The display control unit 107 executes control to display the result of the information processing apparatus 11 for the request from the user terminal 12 or 13.

The storage unit 20 stores the above-described various kinds of programs executed by the CPU, and also stores the above-described models, model information, data, data information, evaluation data, and traceability information.

### <Operation of Apparatus>

This embodiment assumes that the history of the learned models (the initial model, the learning data, and the correction history thereof) is registered as the traceability information (FIG. 6) on the learning model public platform. A method of implementing a higher learning accuracy when performing incremental learning for the above-described learned model will be described. More specifically, one or more models linked by the traceability information are evaluated using predetermined evaluation data, and learning data linked with a model whose evaluation value is high is selected, thereby performing incremental learning (relearning).

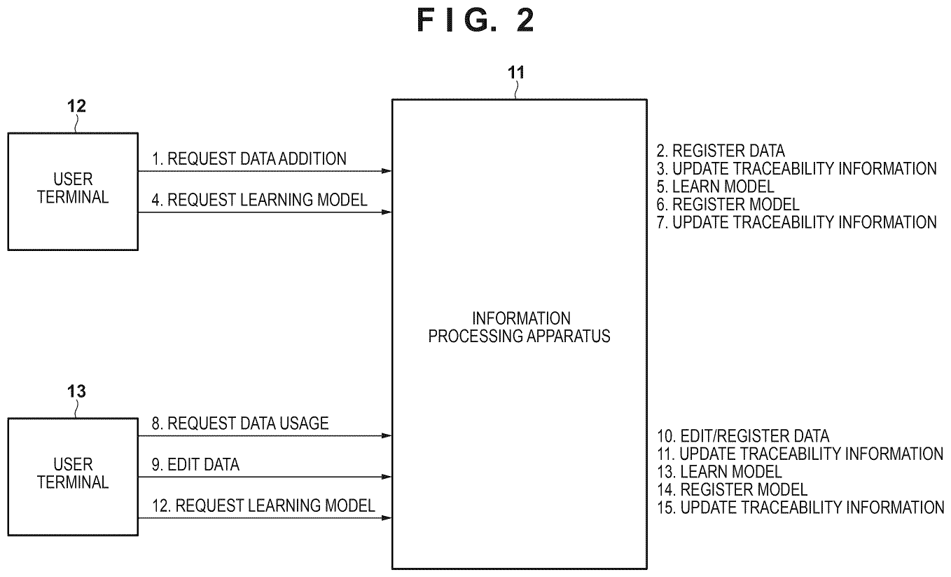

FIG. 2 is a view showing the procedure of processing in the information processing apparatus in response to a request from the user terminal. Processes 1 to 7 shown in FIG. 2 exemplarily indicate processing of adding new data to existing data sets and performing incremental learning for the model. On the other hand, processes 8 to 15 shown in FIG. 2 exemplarily indicate processing of editing at least some of the existing data sets and performing incremental learning for the model.

The following description assumes that a model 600 and the models 601 and 602 are registered in advance via processes 1 to 7 or processes 8 to 15 shown in FIG. 2. In this example, assume that user 0 registers the model 600 (“m0000”), user 1 registers the model 601 (“m0001”), and user 2 registers the model 602 (“m0002”). With the registration of the model by each user, the models 600 to 602 are stored in the storage unit 20. Furthermore, the above-described model information (FIG. 4), data information (FIG. 5), and traceability information (FIG. 6) are registered together (however, a model 607 and information associated with the model 607 have not been registered yet).

Assume here that user 2 wants to detect “the whole body of a person”. However, the target object may be any object, and is not limited. The purpose of performing object detection of a person is to, for example, “cause a camera to focus on the whole body of a person”. Assume also that user 0 wants to detect “a dog” and user 1 wants to detect “the trunk of a person”.

FIG. 3 is a flowchart when the information processing apparatus 11 performs incremental learning (relearning) of the model. A status in which user 2 performs incremental learning for the model 602 and registers the model 607 obtained by the incremental learning will be exemplified. More specifically, a method of improving the learning accuracy with respect to the model 602 (that is, a method of detecting “the whole body of a person” more appropriately) will be described. The following processing is started when the information processing apparatus 11 receives an instruction of incremental learning for the model 602 (“m0002”) as a predetermined model from user 2 via the user terminal.

In step S301, the associated model/data management unit 104 instructs the model management unit 101 to obtain the model 602 (“m0002”). Furthermore, the associated model/data management unit 104 refers to traceability information 606 added to the model 602. This obtains, as an associated model, the model 601 (“m0001”) linked as the initial model. Similarly, the model 600 (“m0000”) linked as the initial model with the model 601 is obtained as an associated model. That is, one or more associated models (models 601 and 600) linked with the model 602 are obtained based on the traceability information 606 (model information obtainment). Furthermore, the associated model/data management unit 104 obtains the evaluation data (“e0002”) corresponding to the model 602 from the data management unit 102.

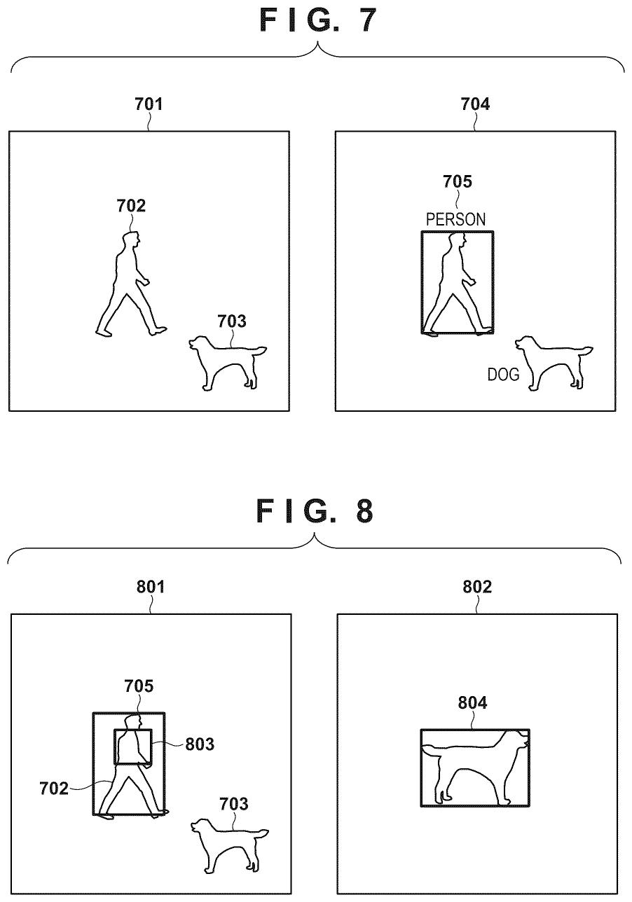

FIG. 7 is a view showing an example of a data set used for learning or evaluation in object detection. The data set used for learning or evaluation includes an image 701 and a ground truth 704. The image 701 is an image including an object which the user wants to recognize. In this example, in addition to a person 702 as an object which user 2 wants to recognize, a dog 703 as an object which need not be recognized is included.

To learn object detection, not only an image but also object information as a Ground Truth (GT) is necessary. The object information is, for example, bounding box information (BB information) corresponding to information of the position and size of a detection target object in the image. A BB 705 is a BB corresponding to the person 702. That is, the data set includes one or more pairs of images and ground truths corresponding to the images.

In step S302, the learning/evaluation unit 105 obtains an evaluation value representing an evaluation accuracy with respect to each of the associated models (models 600 to 602) using the evaluation data (“e0002”) obtained in step S301. For example, a value indicating how close each model is to the ground truth given to the evaluation data (“e0002”) is derived (calculated) as the evaluation value. As an example, Intersection over Union (IoU) indicating how close the BB of the ground truth and the BB estimated by the model are can be derived as the evaluation value. In this case, the average for IoU with respect to all the BBs given to the evaluation data is calculated. Alternatively, the precision, Recall, Receiver Operating Characteristic (ROC) curve, Area under an ROC curve (AOU), or the like can be used as the evaluation value.

In step S303, based on the evaluation value obtained from each associated model, the learning/evaluation unit 105 determines the learning data that is useful to improve the accuracy of the model 602 (“m0002”). For example, if the evaluation value for a given associated model is equal to or higher than a predetermined accuracy, it is determined that the learning data used to learn the associated model is useful. The reason why it is determined that the learning data with a high evaluation value is useful is that as the evaluation value is higher, the learning data used for the corresponding associated model more highly probably includes, as a ground truth, the same target as that to be currently learned.

FIG. 8 is a view for explaining a difference in ground truth due to different target. An image 801 exemplarily shows a ground truth given by user 1. On the other hand, an image 802 exemplarily shows a ground truth given by user 0. That is, as described above, since user 1 wants to detect “the trunk of a person”, a BB corresponding to “the trunk of a person” is set as a ground truth 803 for the image 801. On the other hand, since user 0 wants to detect “a dog”, a BB corresponding to “a dog” is set as a ground truth 804 for the image 802. However, user 2 wants to detect “the whole body of a person” (corresponding to the BB 705).

As described above, even for the same learning data and the same target (in this example, a person), each user (in this example, user 1 or 2) may set a different ground truth. In addition, it is considered that a ground truth for a target (in this example, a dog) that user 2 does not expect at all is given, like the ground truth 804. On the other hand, the evaluation data (“e0002”) prepared by user 2 is often given with respect to “the whole body of a person” like the BB 705, similar to the learning data (“d0002”).

Therefore, evaluation values for the models 600 (“m0000”) and 601 (“m0001”) learned using the BB 803 whose ground truth range is different and the BB 804 whose target object of the ground truth is different tend to be low. However, the BBs 803 and 705 that have different ranges but give the ground truths for the same target (in this example, the person) have an inclusive relationship. Therefore, with respect to the evaluation value such as IoU, the evaluation value for the model (“m0001”) learned using the ground truth having an inclusive relationship is high to some extent. However, the evaluation value for the model (“m0000”) learned using the ground truth having no inclusive relationship is low. That is, the model whose evaluation value of the evaluation data (“e0002”) is higher more highly probably learns the ground truth for the same target object (in this example, the person). When the learning data for the same target each having a ground truth with a similar definition increase, the variations of the learning data can be increased. The increase in variations can suppress overfitting.

In addition, based on the traceability information 606, the model having an evaluation value equal to or higher than the predetermined accuracy may be set as an associated model by tracing (going back) the initial models from the model 602. Then, the learning data used to learn the associated model whose evaluation value is equal to or higher than the predetermined accuracy is determined to be useful, and is used for learning in step S304 to be described later. This can select the learning data for the same target having a similar definition.

Furthermore, a variation in evaluation value for each model caused by tracing the traceability information is checked, and if there is a tendency for the evaluation value to change linearly, it may be determined to obtain the effect of the improved accuracy by a learning order like curriculum-based learning. By performing incremental learning while keeping the learning order, it is possible to improve the learning accuracy by increasing the variations of the learning data while maintaining the effect of the improved accuracy at the time of initial learning of the model 602.

In step S304, the learning/evaluation unit 105 obtains one or more learning data (data sets) determined in step S303 to be useful (data information obtainment), and performs learning. For example, if it is determined in step S303 that the learning data (“d0001”) is useful, this learning data is added to the learning data (“d0002”) to execute learning. Note that a target model for which incremental learning is performed may be the model 602 or 601.

As a learning method of object detection, there is provided, for example, a method using a neural network. Literature A describes details of the learning method of object detection using the neural network. In evaluation executed by the learning/evaluation unit 105 in step S303, the data used for learning or arbitrary data can be used.
(Literature A) Tian et al., “FCOS: Fully Convolutional One-Stage Object Detection”, arXiv: 1904.01355, 2019

In step S305, the learning/evaluation unit 105 registers/stores the model 607 (“m0002′”) obtained by the incremental learning in the model management unit 101.

In step S306, the traceability information management unit 103 updates the traceability information. For example, if incremental learning is performed for the model 602 using the learning data (“d0002” and “d0001”) to create the model 607, the traceability information is updated as shown in FIG. 6.

As described above, according to the first embodiment, when determining learning data to be used to perform incremental learning (relearning) of the model, data to be used for incremental learning is determined using the traceability information. The traceability information indicates records obtained by editing the models and the data in the past. In particular, based on the evaluation value obtained from the associated model of the learning target model, an associated model learned using learning data including a ground truth with a similar definition is determined. By performing incremental learning (relearning) of the model using learning data used to learn the determined associated model, it is possible to perform learning by increasing the variations of the learning data, thereby improving the learning accuracy.

Note that in the above description, a set of an image and a ground truth has been exemplified as learning data but a set of an image and a ground truth need not always be used. For example, a set of a speech or text and a ground truth may be used or only an image, a speech, or text may be used. A combination of an image and text may also be possible. The present invention may be applied to not only image recognition like the above-described object detection but also prediction/recognition of time-series data or natural language processing such as text classification. Note that the traceability information may be distributed and managed using blockchain technology instead of being unitarily managed by the information processing apparatus 11.

### Second Embodiment

The second embodiment will describe a form in which learning data linked by traceability information is evaluated based on intermediate features. That is, the second embodiment is different from the first embodiment in terms of an evaluation method in a learning/evaluation unit 105. A functional configuration (FIG. 1) is the same as in the first embodiment and a description thereof will be omitted. A case where model information (FIG. 4), data information (FIG. 5), and traceability information (FIG. 6) are also the same as in the first embodiment will be described.

### <Operation of Apparatus>

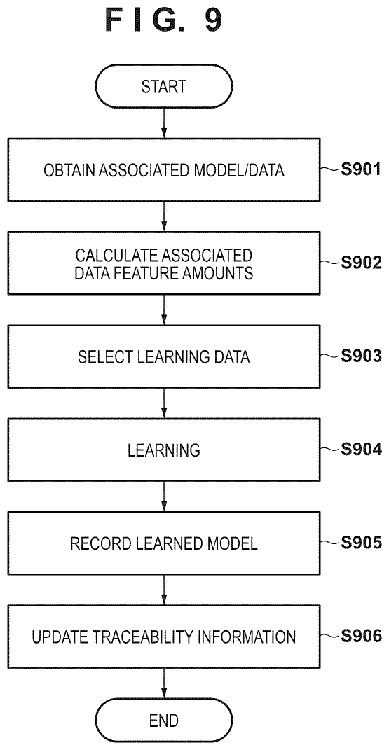

FIG. 9 is a flowchart of learning processing in an information processing apparatus according to the second embodiment. Similar to the first embodiment, a status in which user 2 performs incremental learning for a model 602 and registers a model 607 obtained by the incremental learning will be exemplified. The following processing is started when an information processing apparatus 11 receives an instruction of incremental learning for the model 602 (“m0002”) from user 2 via a user terminal.

In step S901, an associated model/data management unit 104 obtains the model 602 and one or more associated models (models 601 and 600) linked with the model 602 based on traceability information 606, similar to the first embodiment. Furthermore, the associated model/data management unit 104 obtains learning data (“d0001” and “d0000”) used to learn the associated models (models 601 and 600) from a data management unit 102.

In step S902, the learning/evaluation unit 105 calculates feature amounts associated with the learning data obtained in step S901. More specifically, the learning/evaluation unit 105 inputs some or all of the learning data (“d0001” and “d0000”) obtained in step S901 to the model 602 (“m0002”) as the target of incremental learning, and obtains feature amounts extracted by the model at this time. The extracted feature amounts are some (“intermediate features”) of the outputs of the layers obtained at the time of inference in the case of the same DNN-based model as in object detection described in the first embodiment.

The learning/evaluation unit 105 calculates the similarity between data (“d0002”) and another data (in this example, “d0000” or “d0001”) using the extracted intermediate features. The similarity calculation method may be any method as long as it is possible to quantitatively measure the relationship between the intermediate features in a feature space. Assume here that the COS similarity is used as an example of the similarity. Non-patent literature 1 describes details of a method of comparing the intermediate features of the DNN by the COS similarity.

If each learning data includes a lot of data, the similarity between the learning data may be calculated using m data sampled from each learning data. As a sampling method, a method (a random sampling method or the like) that hardly applies a bias to a population is preferably used.

In step S903, the learning/evaluation unit 105 selects, as associated learning data, the learning data for which the similarity calculated in step S902 is equal to or higher than a predetermined value. Alternatively, the similarity between the learning data can be obtained based on the average or variance of the COS similarities, and used as a criterion for selection. The thus selected learning data is associated data.

Details of similarity comparison will be described. A method of comparing the similarity between the data (“d0001”) and the data (“d0002”) will be explained as an example. First, m samples are extracted from the data (“d0001”), and m samples are extracted from the data (“d0002”). At this time, with respect to each group of the m samples, intermediate features are calculated using the model 602 (“m0002”). Thus, m intermediate features are obtained for each of the data (“d0001”) and the data (“d0002”). The COS similarities are calculated for all the combinations (m×m combinations), and the sum of the COS similarities for all the combinations is set as the similarity between the learning data.

Note that as the number (m) of samples increases, the possibility that outliers are mixed in the samples is higher. To cope with this, the COS similarities may be calculated for all the combinations (m×m combinations), and a smaller number of representative values with high likelihood may be selected. A practical method is described in detail in non-patent literature 1.

Subsequently, in steps S904 to S906, incremental learning of the model 602 is performed, an obtained model is registered/stored, and traceability information is updated, similar to the first embodiment.

As described above, according to the second embodiment, when determining learning data to be used to perform incremental learning (relearning) of the model, data to be used for incremental learning is determined using the traceability information. In particular, the similarity between learning data used to learn a learning target model and learning data used to learn each associated model is calculated. By performing incremental learning (relearning) of the model using the learning data having a higher similarity, it is possible to perform learning by increasing the variations of the learning data, thereby improving the learning accuracy.

### Modification

Each of the above-described embodiments has exemplified learning of an object detection model but the present invention can similarly be applied to learning of another type of model. As a modification, a form in which the present invention is applied to an image generation model used in an image generation task will be described. An image generation AI is image generation technology represented by literature B.
(Literature B) Rombach et al., “High-Resolution Image Synthesis with Latent Diffusion Models”, CVPR 2022, arXiv: 2112.10752, 2021

Note that the functional configuration and the operation of an information processing apparatus are the same as those in the first embodiment (FIGS. 1 to 3) and a description thereof will be omitted. However, the modification is different in that a character string (text) is used as data of a ground truth used to learn a model, instead of a BB.

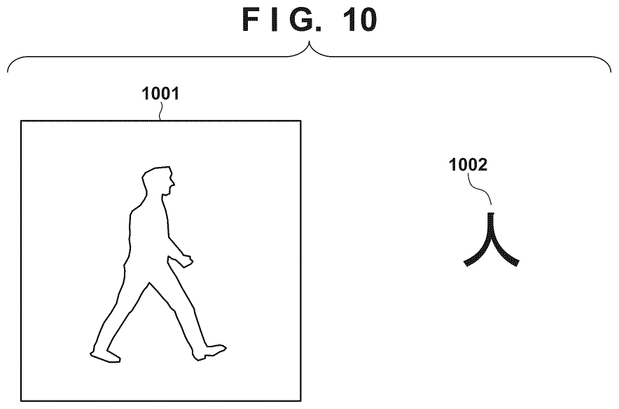

FIG. 10 is a view showing an example of learning data according to the modification. The learning data includes an image 1001 and a ground truth 1002. The image 1001 is an image including an object (in this example, a person) which the user wants to recognize. To learn a model of an image generation task, not only an image but also object information as a ground truth (GT) is necessary. The object information is, for example, text representing an object in the image. As for the ground truth 1002, “a Kanji (Chinese) character meaning “human”” is designated as text corresponding to the object included in the image 1001.

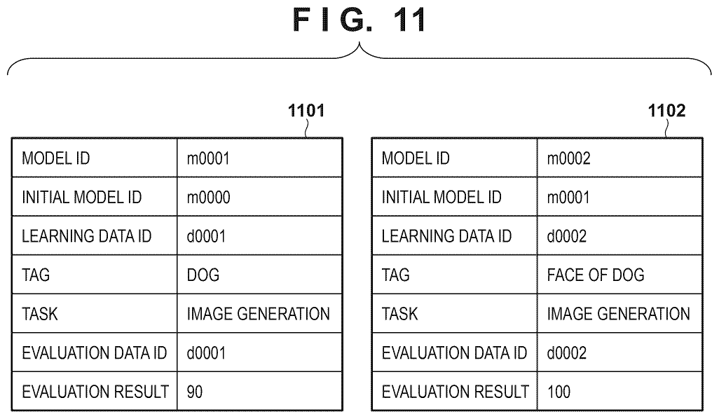

FIG. 11 shows tables each showing an example of information added to data according to the modification. Assume here that user 1 creates the model (“m0001”) using the data (“d0001”) shown in FIG. 10 with respect to the initial model (“m0000”), and publishes the model on the learning model public platform. In this case, user 2 who uses the learning model public platform can create the model (“m0002”) using the data (“d0002”) created by himself/herself with respect to the published model (“m0001”).

As described above, in the modification, the ground truth is not a BB but a character string for explaining an object. In this case, as an evaluation value, a value calculated by an error function or a value obtained by converting each evaluation image into a predetermined intermediate feature (embedded expression) and using the average or variance of the intermediate features can be used. As an example, a method of evaluating a model with respect to evaluation data using Frechet Inception Distance (FID) will be described.

First, two types of embedded expressions, that is, an embedded expression obtained by inputting the evaluation data (FIG. 10) to the learned model (in this example, “m0001”) and an embedded expression obtained by inputting an image output from the model (“m0002”) to the learned model are calculated. The average or variance of the embedded expressions in an embedded expression space is calculated, and the similarity between the two types of embedded expressions is calculated. In the case of a task for generating an image with higher likelihood, as FID is lower, a higher evaluation value is obtained. Then, similar to the first embodiment, the learning data used to learn the model whose evaluation value is higher than the predetermined value is determined to be useful, and is used to learn the model (“m0002”).

Similar to the second embodiment, it is possible to calculate the similarity using the model (“m0002”) for some or all of the learning data linked by the traceability information. That is, m samples are extracted with respect to each associated model. An embedded expression is calculated based on the obtained samples by the model (“m0002”), and the similarity between the learning data is calculated based on an index such as the above-described FID. It can be said that the learning data with a higher similarity has a feature closer to the property of the already learned model (“m0002”). Therefore, if the similarity is lower than the predetermined value, the learning data is determined as associated learning data. Literature B described above describes details of learning (step S304) of the model (“m0002”).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-038767, filed Mar. 13, 2024, which is hereby incorporated by reference herein in its entirety.

What is claimed is:

1. An information processing apparatus for managing a plurality of learning models, comprising:
a model management unit that manages, for each of the plurality of learning models, first information for identifying a data set used to learn the learning model, and second information for identifying an initial model used to learn the learning model;
a data management unit that manages third information concerning a plurality of data sets each identified by the first information of each of the plurality of learning models;
a reception unit that receives an instruction of incremental learning using, as an initial model, a predetermined learning model included in the plurality of learning models; and
a determination unit that determines, based on the first information, the second information, and the third information, a data set to be used for the incremental learning from the plurality of data sets,
wherein the determination unit determines, as a data set to be used for the incremental learning, a data set used to learn a learning model whose evaluation accuracy is not lower than a predetermined accuracy at the time of inputting a predetermined data set to each of at least one learning model used as the initial model of the predetermined learning model.

2. The apparatus according to claim 1, wherein
the model management unit further manages fourth information for identifying a data set used to evaluate the learning model, and
the predetermined data set is a data set used to evaluate the predetermined learning model.

3. The apparatus according to claim 1, wherein
the predetermined data set includes at least one pair of an image and a ground truth corresponding to the image.

4. The apparatus according to claim 3, wherein
the plurality of learning models are object detection models, and
the ground truth is bounding box information of a detection target object included in the image.

5. The apparatus according to claim 3, wherein
the plurality of learning models are image generation models, and
the ground truth is a character string indicating an object included in the image.

6. An information processing apparatus for managing a plurality of learning models, comprising:
a model management unit that manages, for each of the plurality of learning models, first information for identifying a data set used to learn the learning model, and second information for identifying an initial model used to learn the learning model;
a data management unit that manages third information concerning a plurality of data sets each identified by the first information of each of the plurality of learning models;
a reception unit that receives an instruction of incremental learning using, as an initial model, a predetermined learning model included in the plurality of learning models; and
a determination unit that determines, based on the first information, the second information, and the third information, a data set to be used for the incremental learning from the plurality of data sets,
wherein the determination unit determines, as a data set to be used for the incremental learning, a data set whose similarity with a first data set used to learn the predetermined learning model among at least one data set used to learn each of at least one learning model used as the initial model of the predetermined learning model is not lower than a predetermined value.

7. The apparatus according to claim 6, wherein
the determination unit derives the similarity by comparing a feature amount obtained by inputting the at least one data set to the predetermined learning model and a feature amount obtained by inputting the first data set to the predetermined learning model.

8. A control method for an information processing apparatus that manages a plurality of learning models, comprising:
obtaining, for each of the plurality of learning models, first information for identifying a data set used to learn the learning model, and second information for identifying an initial model used to learn the learning model;
obtaining third information concerning a plurality of data sets each identified by the first information of each of the plurality of learning models;
receiving an instruction of incremental learning using, as an initial model, a predetermined learning model included in the plurality of learning models; and
determining, based on the first information, the second information, and the third information, a data set to be used for the incremental learning from the plurality of data sets,
wherein in the determining, a data set used to learn a learning model whose evaluation accuracy is not lower than a predetermined accuracy at the time of inputting a predetermined data set to each of at least one learning model used as the initial model of the predetermined learning model is determined as a data set to be used for the incremental learning.

9. A control method for an information processing apparatus that manages a plurality of learning models, comprising:
obtaining, for each of the plurality of learning models, first information for identifying a data set used to learn the learning model, and second information for identifying an initial model used to learn the learning model;
obtaining third information concerning a plurality of data sets each identified by the first information of each of the plurality of learning models;
receiving an instruction of incremental learning using, as an initial model, a predetermined learning model included in the plurality of learning models; and
determining, based on the first information, the second information, and the third information, a data set to be used for the incremental learning from the plurality of data sets,
wherein in the determining, a data set whose similarity with a first data set used to learn the predetermined learning model among at least one data set used to learn each of at least one learning model used as the initial model of the predetermined learning model is not lower than a predetermined value is determined as a data set to be used for the incremental learning.

10. A non-transitory computer-readable recording medium storing a program that, when executed by a computer, causes the computer to perform a control method for an information processing apparatus that manages a plurality of learning models, comprising:
obtaining, for each of the plurality of learning models, first information for identifying a data set used to learn the learning model, and second information for identifying an initial model used to learn the learning model;
obtaining third information concerning a plurality of data sets each identified by the first information of each of the plurality of learning models;
receiving an instruction of incremental learning using, as an initial model, a predetermined learning model included in the plurality of learning models; and
determining, based on the first information, the second information, and the third information, a data set to be used for the incremental learning from the plurality of data sets,
wherein in the determining, a data set whose similarity with a first data set used to learn the predetermined learning model among at least one data set used to learn each of at least one learning model used as the initial model of the predetermined learning model is not lower than a predetermined value is determined as a data set to be used for the incremental learning.
